(19) United States
(12) Patent Application Publication
(10) Pub. No.: US 2015/0260091 A1
(43) Pub. Date: Sep. 17, 2015

(54) EXTERNAL COOLING FIN FOR ROTARY ENGINE

(71) Applicant: Chung-Shan Institute of Science and Technology, Armaments Bureau, M.N.D, Taoyuan County (TW)

(72) Inventors: Ming-Chun Hsieh, Taoyuan County (TW); Dun-Zen Jeng, Taoyuan County (TW); Chih-Chuan Lee, Taoyuan County (TW); Ting-Hua Chieh, Taoyuan County (TW)

(73) Assignee: Chung-Shan Institute of Science and Technology, Armaments Bureau, M.N.D, Taoyuan County (TW)

(21) Appl. No.: 14/213,459

(22) Filed: Mar. 14, 2014

(51) Int. Cl. F02B 55/12

(52) U.S. Cl. CPC F02B 55/12

(57) ABSTRACT

An external cooling fin of a rotary engine is mounted onto the housings of the rotary engine and includes a plurality of cooling teeth for lowering the temperature of the rotary engine, and each cooling fin includes a root and two or more outstretching fin stems, and the root is coupled to the rotary engine housings, so as to achieve a high-efficiency heat dissipation.

### BACKGROUND OF THE INVENTION

1. Field of Invention

The present invention relates to a cooling fin, and particularly to an external cooling fin for a rotary engine.

2. Description of Related Art

In general, an engine cooling system is mainly categorized into a water-cooling type and an air-cooling type. The air-cooling type has two alternatives, a natural air cooling and a compulsory air cooling. The compulsory air cooling inducts external cooling air by a device (such as a compressor) on heat dissipation, but the natural air cooling, by natural airflow from the vehicle speed.

The rotary engine is unique in its assembly, which includes side housings, housing outer casings, center housing, an eccentric shaft and a rotor. The triangular-shaped rotor is aligned in the housings and mounted on the eccentric shaft which the rotor revolves on, and air breathing through the ports on the center housing.

Due to fewer components, the rotary engine, with rotational motion in operation, has the advantages of compact size in comparison to a 3-cylinder piston engine, with reciprocating motion in operation, and also it characterizes with light weight, low fuel consumption, and high thrust/load. Therefore, ordinary cooling system with a relative large size on the piston engine may not be compatible with a rotary engine. With high heat load over limited surface area, a light-weighted fin to extend the exposed surface area for the rotary engine heat dissipation is designed

### SUMMARY OF THE INVENTION

In view of the shortcomings of the prior art, it is a primary objective of the present invention to overcome the shortcomings by applying an external cooling fin to a rotary engine, wherein a rotary engine has several coupled cooling fins, tuning-forklike, atop the housings and side housings to enhance heat dissipation efficiency.

To achieve the aforementioned objective, the present invention provides both side housings and rotor center housing which has several tuning-forklike fins atop for lowering the temperature of the rotary engine. The cooling fins are coupled and rooted on the housing along with its outer surface. And the roots of the tuning-fork-like fins can be in regular or irregular shape, equal or unequal width. The length ratio of the fins to the roots is approximately 2:1. 2-tooth tuning fork fins or multi-tooth fins are included in the present invention.

The gap between the fins can be coarse or fine based on the heat distribution on the housings. More fine-distributed fins are required for high heat load at combustion zone than the others. As to the cold zone close to the intake port, it is not a must to have fins.

The cooling fins are aligned to the center of the crank shaft and extended radially outward from the roots on the housing outer casings, orthogonal or with a tilt angle from the surface.

The root and the outward stem of the cooling fin can be integrally formed as a whole, wherein the cooling fin has a thickness from 1 mm to 3 mm, and a length from 5 cm to 10 cm, but the invention is not limited to such arrangements only.

### BRIEF DESCRIPTION OF THE DRAWINGS

FIG. 1A is a front view of a rotary engine and an external cooling fin of the present invention;

FIG. 1B is a perspective view of a rotary engine and an external cooling fin of the present invention;

FIG. 2 is a sectional view of an external cooling fin for a rotary engine of the present invention;

FIG. 3 is a top view of an external cooling fin for a rotary engine of the present invention;

FIG. 4A is a perspective view of a rotary engine and an external cooling fin in accordance with another embodiment of the present invention;

FIG. 4B is a plane view of a conventional rotary engine and an external cooling fin;

FIG. 4C is a plane view of a rotary engine and an external cooling fin in accordance with another embodiment of the present invention;

FIG. 4D is a plane view of a rotary engine and an external cooling fin in accordance with another embodiment of the present invention; and

FIG. 5 is a sectional view of an external cooling fin in accordance with another embodiment of the present invention.

### DETAILED DESCRIPTION OF THE INVENTION

The technical characteristics and objectives of the present invention can be further understood by the following detailed description of preferred embodiments and related drawings.

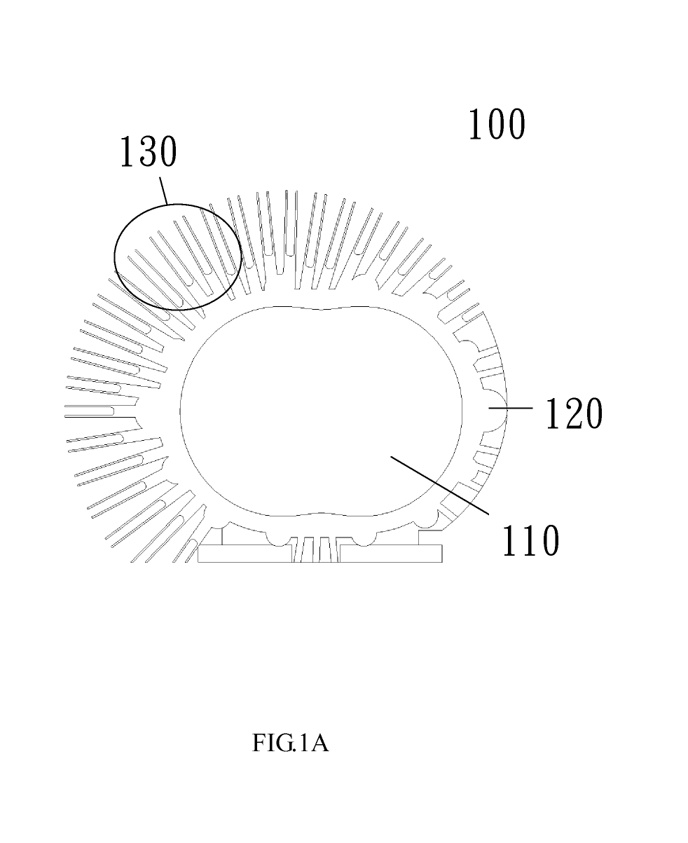

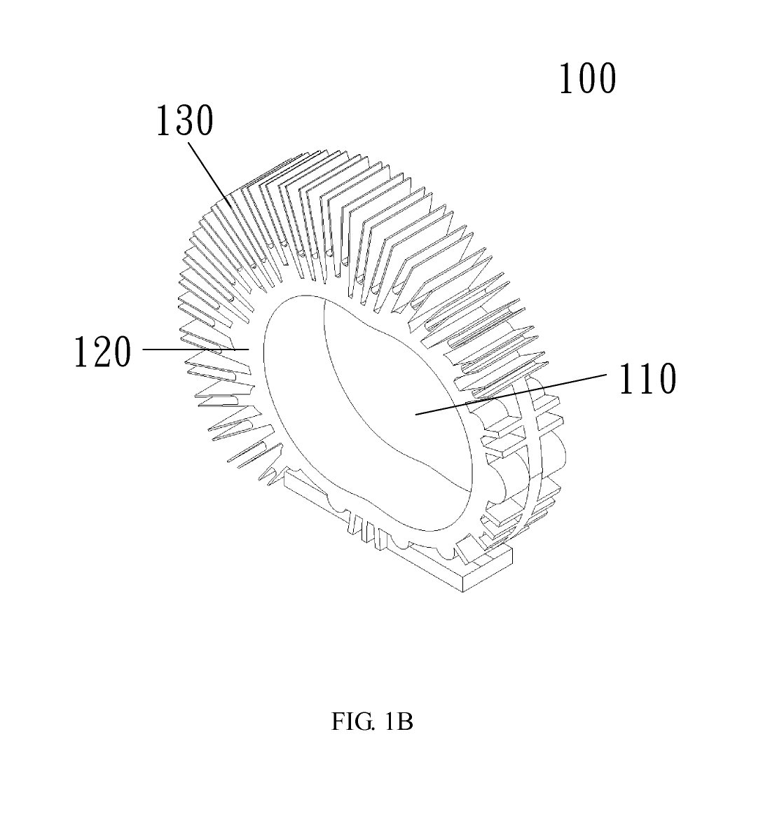

With reference to FIGS. 1A-1B for the front view and the perspective view of a rotary engine and an external cooling fin of the present invention respectively, the rotary engine 100 has a rotor (not shown in the figure) installed in a power chamber 110 of the rotary engine 100 and rotated. When the rotary engine is in operation, a substantial amount of heat is generated, and must be released by a heat dissipation process. In this preferred embodiment, the air cooling system utilizes the plurality of cooling teeth 130, tuning fork like, mounted onto the outer surface of a rotary engine housing 120 to perform the heat dissipation of the rotary engine in order to maintain the small volume and light weight features of the rotary engine. As a part of the rotary engine 100, the cooling teeth can be made of a metal or an alloy, and the heat from the rotary engine can be released through the fins on the rotary engine housing 120 to the air. The cooling effect is dominated by the surface area, therefore the plurality of cooling teeth 130 atop of the rotary engine housings can increase the heat dissipating area to improve the heat dissipation efficiency, wherein the cooling teeth 130 and the rotary engine housing 120 can be integrally formed as a whole or connected to each other as an assembly

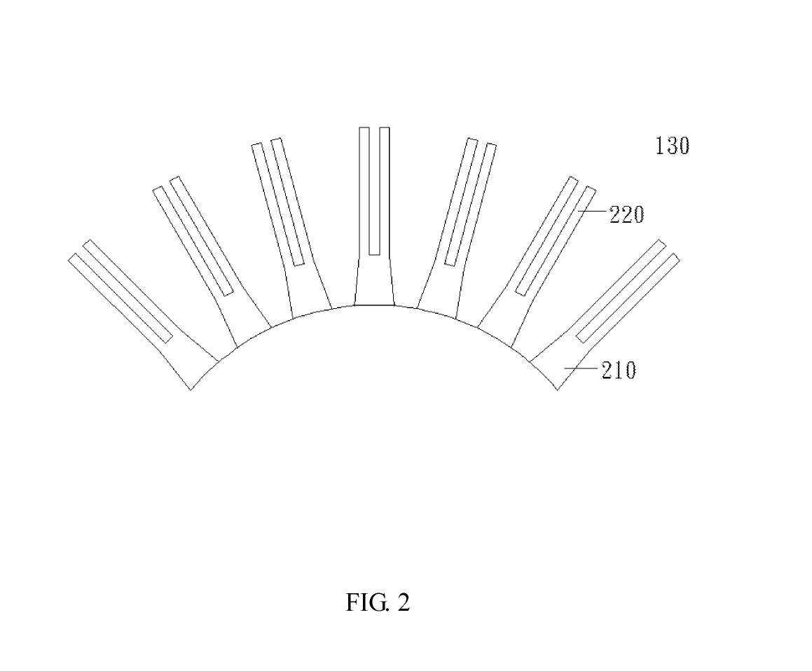

With reference to FIG. 2 for a sectional view of an external cooling fin for a rotary engine in accordance with the present invention, this figure is a sectional view of the cooling fin 130f FIG. 1.

Each of the coupled cooling teeth 130, tuning fork like, includes a root 210 that stretches outward into two teeth 220, and the root 210 is disposed at the bottom of the cooling fins 130, and coupled to the rotary engine housing 120 The root 210 and the rotary engine housing 120 can be integrally formed as a whole, or connected to each other as an assembly. The heat generated from the combustion of the engine conducts through the root 210 on the housing to the fins 220.

The two-tooth fins 220 enlarge the exposed surface area for dissipating the heat effectively, so that different outward stretching fin teeth such as a three, or a four is included in the present invention. In this preferred embodiment, the two-tooth fin is used to improve the heat dissipation efficiency. The length ratio of the fin tooth 220 to the root 210 will be ranged from 1 to 3.

In this preferred embodiment, the length ratio of the root 210 to the fin tooth 220 is approximately 1:2. In other words, the root length takes one third of the total length, from the bottom of the root to the fin tip. In this preferred embodiment, the thickness of the cooling fin 130 ranges from 1 mm to 3 mm, and the length from 5 cm to 10 cm, but the invention is not limited to such ranges only.

The cooling teeth 130 are radially, to the crank shaft center, stretched outward from the root 210 and distributed circumferentially along the engine housing, so the gap at the bottom of the cooling fin 130 is narrower than that at the tip of the cooling fin 130.

The heat distribution of the rotary engine 100 is not uniform. For instance, higher temperature appears at the ignition location of the rotary engine 100, and lower temperature, around the intake port of the rotary engine 100. If the cooling teeth 130 of the rotary engine 100 are equal spaced on the rotary engine, then the fins at high temperature zone close to ignition location will be insufficient or the fins at low temperature zone close to the intake port will be more than necessary and increase the overall weight. In this preferred embodiment, the cooling teeth 130 are distributed with different densities based on the heat load distribution. Therefore, the cooling fins at high heat zone, between ignition location and the exhaust port, takes high density distribution to offer sufficient exposed surface area for heat dissipation. The cooling fins at the low temperature zone, between the intake port to the ignition location, takes low density distribution or no fins required there in order not to have an excess weight.

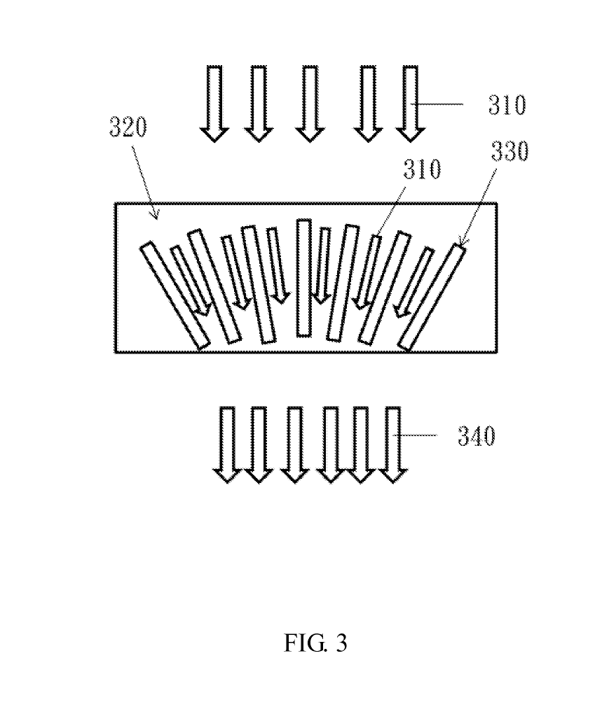

With reference to FIG. 3, the top view of an external cooling fin for a rotary engine of the present invention, the cooling fins are not necessarily aligned axially parallel to each other. The cooling air goes from upstream 310 through the gaps 320 between the fins 330 to downstream 340 in axial direction. To enlarge air capture area, the fins can be aligned in a V-shape with a larger gap distance at the upstream and a smaller gap distance at the downstream. More air flow through the fin gaps will be beneficial to the heat exchange, and achieve a better efficiency in heat dissipation.

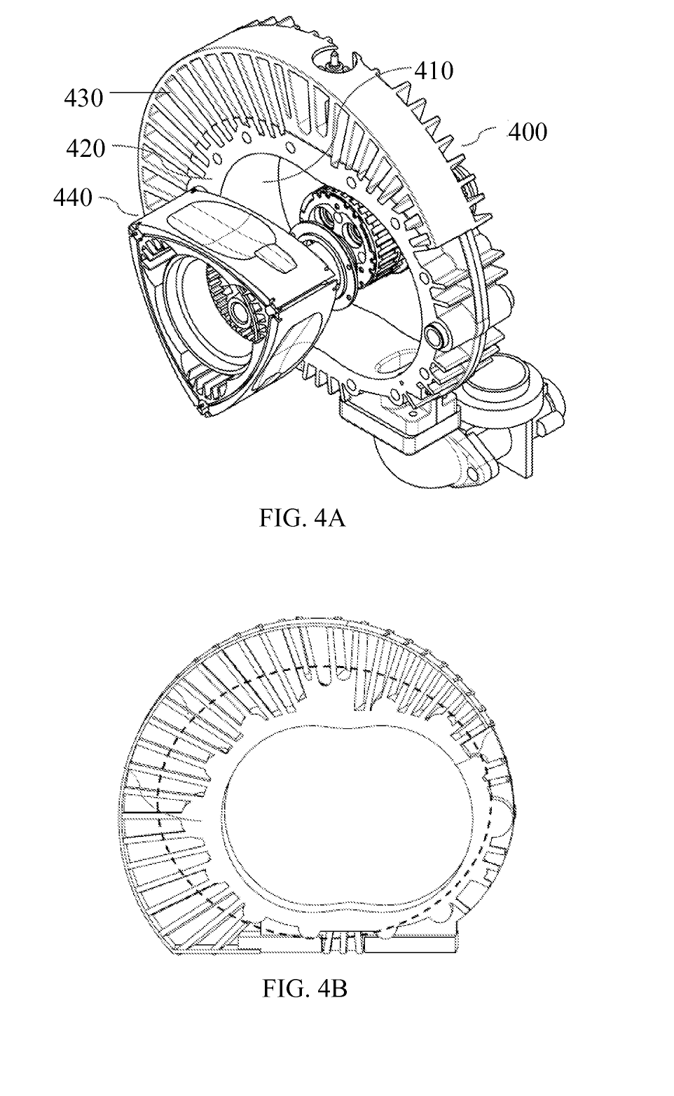

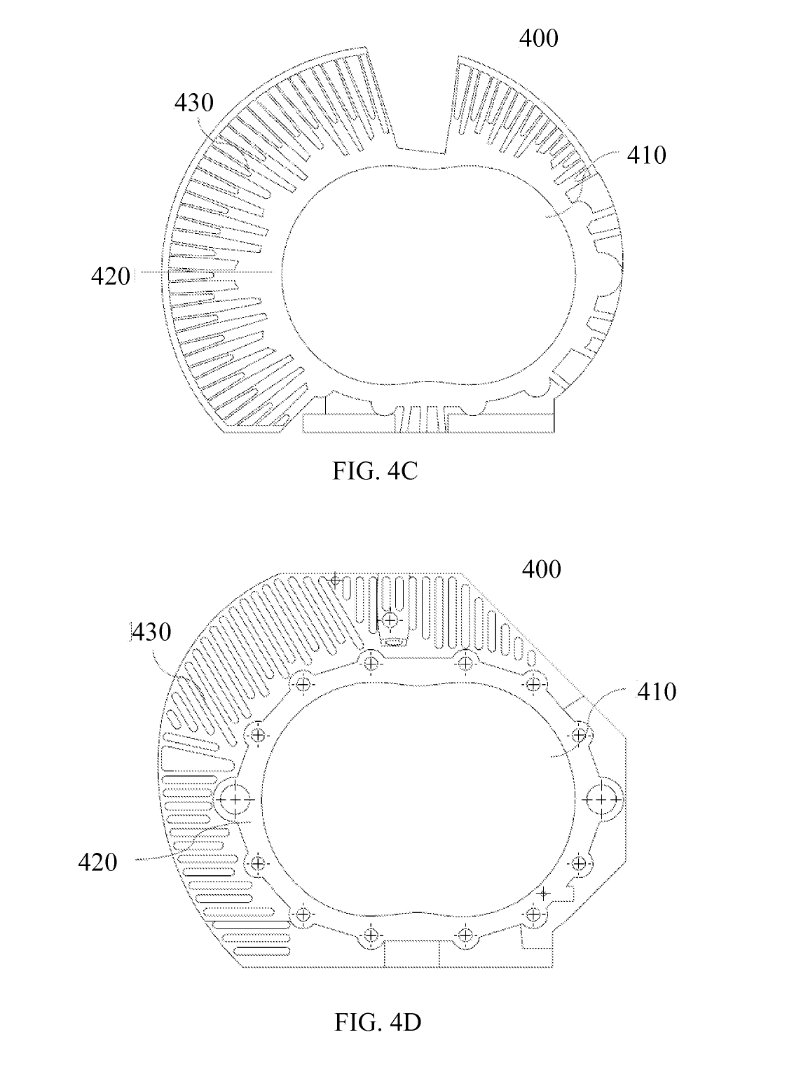

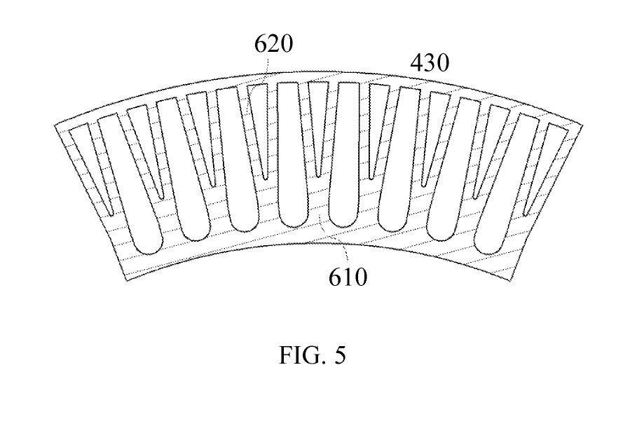

With reference to FIGS. 4A for the perspective view of a rotary engine and an external cooling fin, the rotary engine 400 has a rotor 440 installed in the chamber 410 of the rotor housing of the rotary engine 400 and rotated. When the rotary engine is in operation, a substantial amount of heat is generated, and must be released by a heat dissipation process. With reference to FIG. 4B of a traditional air-cooled rotary engine, the gap between fins is larger at the tip due to radially alignment.

In this preferred embodiment of the present invention in FIG. 4C and 4D, the air cooling system utilizes the plurality of cooling teeth 430, tuning fork like or branch-shaped, mounted onto the periphery of the rotor housing 420 radially out-stretching with more fins at the tip in V shape or with tilt angle in parallel to perform the heat dissipation of the rotary engine in order to maintain the small volume and light weight features of the rotary engine. As a part of the rotary engine 400, the cooling teeth can be made of a metal or an alloy, and the heat from the rotary engine can be released through the fins 430 on the rotary engine housing 420 to the air. The cooling effect is dominated by the surface area, therefore the plurality of cooling teeth 430 atop of the rotary engine housings in the present invention can effectively increase the surface area to improve the heat dissipation efficiency, wherein the cooling teeth 430 and the rotary engine housing 420 can be integrally formed as a whole or connected to each other as an assembly

With reference to FIG. 5 for a sectional view of the external cooling fins for a rotary engine in accordance with the present invention, this figure is a sectional view of the cooling fin 430 in FIG. 4C. Each of the coupled cooling teeth 430, tuning fork like, includes a root 610 that stretches outward into two or more teeth 620, and the root 610 is at the bottom of the cooling fins 430 onto the periphery of the rotor housing 420 The root 610 and the rotor housing 420 can be integrally formed as a whole or as an assembly. The heat generated from the combustion of the engine conducts through the root 610 on the housing to the fins 620.

The two-tooth fins 620 enlarge the exposed surface area for dissipating the heat effectively at the tip, so that different outward stretching fin teeth such as a three, a four or a branch-shaped is included in the present invention. In this preferred embodiment, the two-tooth fin is used to improve the heat dissipation efficiency. The length ratio of the fin tooth 620 to the root 610 will be ranged from 1 to 3.

In this preferred embodiment, the length ratio of the root 610 to the fin tooth 620 is approximately 1:2. In other words, the root length takes one third of the total length, from the bottom of the root to the fin tip. In this preferred embodiment, the thickness of the cooling fin 430 ranges from 1 mm to 3 mm, and the length from 5 cm to 10 cm, but the invention is not limited to such ranges only.

The cooling teeth 430 are radially, to the crank shaft center, stretched outward from the root 610 and distributed circumferentially along the rotor housing or with a tilt angle to the root surface, so the gap at the bottom of the cooling fin 430 would be close to the gap at the tip.

The heat distribution of the rotary engine 400 is not uniform. For instance, higher temperature appears at the ignition location of the rotary engine 400, and lower temperature, around the intake port of the rotary engine 400. If the cooling teeth 430 of the rotary engine 400 are equal spaced on the rotary engine, then the fins at high temperature zone close to ignition location will be insufficient or the fins at low temperature zone close to the intake port will be more than necessary and increase the overall weight. In this preferred embodiment, the cooling teeth 130 are distributed with different densities based on the heat load distribution. Therefore, the cooling fins at high heat zone, between ignition location and the exhaust port, takes high density distribution to offer sufficient exposed surface area for heat dissipation. The cooling fins at the low temperature zone, between the intake port to the ignition location, takes low density distribution or no fins required there in order not to have an excess weight as shown in FIG. 4C and 4D.

The specific cooling fins in the present invention offer a high air cooling efficiency by increasing the exposed surface area. With its simplicity in function and no other auxiliary devices required, the cooling fins of the present invention effectively fit to a compact engine compartment such as a light sport aircraft. To enhance heat dissipation efficiency, continuous fin design and testing are required in sizes, shapes, and density alignments to secure a stable rotary engine operation. The external cooling fins in the present invention are typically used in a rotary engine to achieve a better heat dissipation efficiency for a more stable engine operation.

While the invention has been described by means of specific embodiments, numerous modifications and variations could be made thereto by those skilled in the art without departing from the scope and spirit of the invention set forth in the claims.

What is claimed is:

1. An external cooling fin of a rotary engine, installed on the housings of the rotary engine, comprising:
a plurality of cooling teeth, for dissipating the temperature of the rotary engine, and each of the cooling fins including a root where two or more fin teeth stretch radially outward, and the root coupled to the rotary engine housing outer surface.

2. The external cooling fin of a rotary engine according to claim 1, wherein the root and the outstretching cooling teeth have a length ratio approximately 1:2.

3. The external cooling fin of a rotary engine according to claim 1, wherein the outstretching cooling teeth are two separate stems, tuning fork alike.

4. The external cooling fin of a rotary engine according to claim 1, wherein the cooling teeth are distributed with different density alignments.

5. The external cooling fin of a rotary engine according to claim 4, wherein the cooling teeth are high-density distributed at high heat-load zone from ignition location to exhaust port location.

6. The external cooling fin of a rotary engine according to claim 1, wherein the cooling fins are aligned in top view, from upstream to downstream, in a V-shape, wider gap distance at the upstream, or parallel to each other.

7. The external cooling fin of a rotary engine according to claim 1, wherein the root and the outstretching teeth are integrally formed as a whole.

8. The external cooling fin of a rotary engine according to claim 1, wherein the cooling fin has a thickness from 0.5 mm to 8 mm, and a length from 5 cm to 10 cm.

9. The external cooling fin of a rotary engine according to claim 1, wherein the cold zone of the rotary engine, close to the intake port, may have no cooling fin installed thereon.
